(19) United States
(12) Patent Application Publication
(10) Pub. No.: US 2008/0270308 A1
(43) Pub. Date: Oct. 30, 2008

(54) Method and Apparatus for Providing a Secure Trick Play

(75) Inventors: Petr Peterka, San Diego, CA (US); Alexander Medvinsky, San Diego, CA (US); Paul Moroney, Olivenhain, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/843,335

(22) Filed: Aug. 22, 2007

Related U.S. Application Data
(60) Provisional application No. 60/914,431, filed on Apr. 27, 2007.

(51) Int. Cl. G06Q 10/00

(52) U.S. Cl. 705/51

(57) ABSTRACT

A process may be utilized by a DVR. The process characterizes a set of content as a plurality of segments as the set of content is received. Each of the segments has a segment length according to a predetermined time interval. Further, the process encrypts each of the segments with a corresponding content encryption key to generate a plurality of encrypted segments. The corresponding content encryption key for each of the segments is generated by the DRM component. In addition, the process stores each of the encrypted segments for playback with trick play features in accordance with an expiration content rule having a time limit on the temporary playability of the set of content.

### RELATED APPLICATIONS

This application claims priority to U.S. Provisional Application Ser. No. 60/914,431 entitled “Secure Pause,” filed on Apr. 27, 2007, the content of which is incorporated herein by reference in its entirety.

### BACKGROUND

1. Field

This disclosure generally relates to the field of audio/visual content. More particularly, the disclosure relates to the management of rights associated with audio/visual content.

2. General Background

A recording device such as a Digital Video Recorder (“DVR”) records real-time content coming from sources such as cable, satellite, or broadband sources. The content generally has a content license associated with it that specifies the rights associated with the content.

Protected content marked as copy-never is generally restricted from being recorded by content providers. For instance, a cable provider may wish to prevent a user from recording a pay-per-view set of content. However, users have become accustomed to utilizing features such as trick plays, e.g., pause, fast forward, rewind, and jump. Accordingly, content providers have made exceptions for copy-never content to allow users to utilize pause and trick plays on copy-never content for a temporary period of time. The content providers generally prevent a permanent recording for copy-never content, but may allow a temporary recording that is limited to a short predefined amount of time, e.g., ninety minutes, to allow for the pause and trick play features.

Current approaches do not adequately provide security for the temporary recording of copy-never content. The current approaches are typically based upon a buffer on the DVR hard drive, or other memory, that is only as large as the allowed amount of buffer time would need. An example of the allowed time may be ninety minutes, but the allowed time may be shorter or longer in duration. These buffers are typically not managed with any great amount of security, but will behave in the desired manner if not attacked illicitly. From a license point of view, a single content key for the copy never content is another approach. However, a single content key makes it difficult for a DRM module to enforce the pause buffer limit. Content decryption is often provided in hardware for enhanced performance, and once that single content key is loaded into hardware, the DRM module is no longer in control. In one example of a two hour movie, the full movie is allowed to be played back for ninety minutes after the event has completed (which would allow the last minute of the movie to be kept for ninety minutes in a pause buffer, but the first minute of the movie can be kept for three and a half hours). This is not what the content owner intended, where a ninety minute duration inside the pause buffer is allowed for each minute of the movie.

### SUMMARY

In one aspect of the disclosure, a process may be utilized by a DVR. The process characterizes a set of content as a plurality of segments as the set of content is received. Each of the segments has a segment length according to a predetermined time interval. Further, the process encrypts each of the segments with a corresponding content encryption key to generate a plurality of encrypted segments. The corresponding content encryption key for each of the segments is generated by the DRM component. In addition, the process stores each of the encrypted segments for playback with trick play features in accordance with an expiration content rule having a time limit on the temporary playability of the set of content.

In another aspect, a process may be utilized by the DRM component. The process composes a content license for a set of content that has a corresponding expiration content rule indicating a time limit on temporary playability of the set of content. The set of content is characterized as a plurality of segments that each has a segment length according to a predetermined time interval. Further, the process inserts a master key into the content license. In addition, the process generates a unique content encryption key for each of the segments so that each of the segments is encrypted to form a plurality of encrypted segments. Finally, the process inserts a plurality of time stamps into the content license. Each of the time stamps corresponds to one of the encrypted segments and indicates a relative time from a recording start time to start of the encrypted segment.

In yet another aspect, a process may be utilized by the DVR. The process characterizes a set of content as a plurality of segments as the set of content is received. Each of the segments has a segment length according to a predetermined time interval. Further, the process encrypts each of the segments with a corresponding content encryption key to generate a plurality of encrypted segments. The corresponding content encryption key for each of the segments is generated by the DRM component. In addition, the process stores each of the encrypted segments for playback with trick play features in accordance with an expiration content rule having a time limit on the temporary playability of the set of content. The process inserts, for each of the encrypted segments, a marker token corresponding to the content encryption key for the encrypted segment into an index file. The marker token includes an index and a content rule set of values associated with the encrypted segment and associated content encryption key so that the content rule set of values associated with the content encryption key is retrieved during trick mode playback.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a DRM environment.

FIG. 2 illustrates the interaction between the DVR, the content protection module, and the content source.

FIG. 3 illustrates an example of a plurality of segments of content that may be recorded.

FIG. 4 illustrates a process that may be utilized by the DVR.

FIG. 5 illustrates a process that may be utilized by the DRM component.

FIG. 6 illustrates another process that may be utilized by the DVR.

FIG. 7 illustrates a block diagram of a station or system that provides secure trick play.

### DETAILED DESCRIPTION

A method and apparatus are disclosed that provide for secure pause and/or secure trick plays. A set of content, which is intended by a content provider to be usable only for a temporary time period, is divided into a plurality of segments. Each of the segments is encrypted with a unique key. Further, an expiration time is associated with each one of the unique keys so that the respective key can be utilized only up until the expiration time to decrypt the corresponding segment. As a result, features such as pause or trick plays may be utilized for a predetermined time measured with respect to each segment.

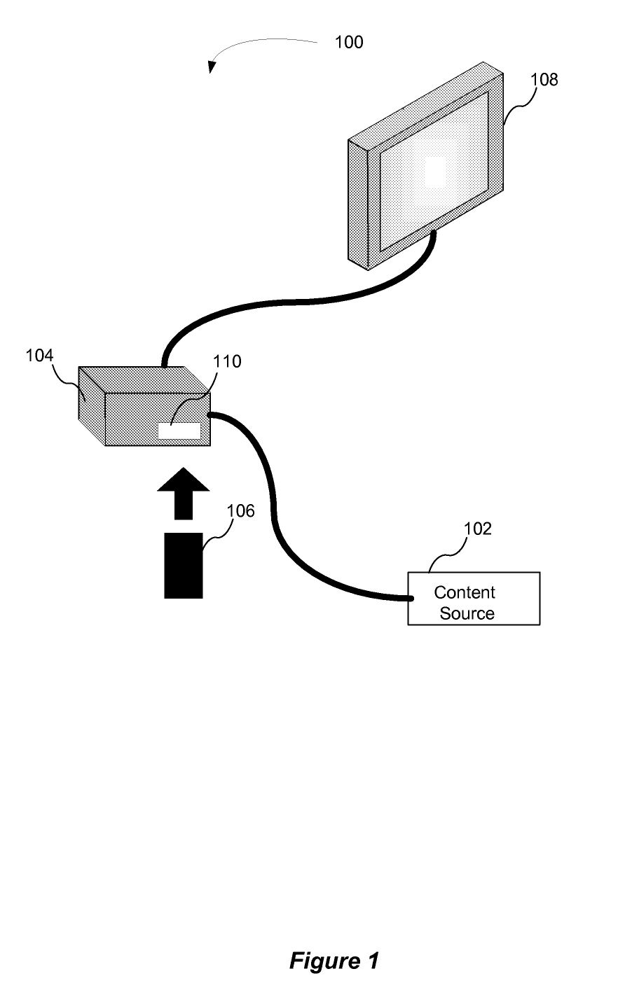

FIG. 1 illustrates a DRM environment 100. A content source 102, such as a content provider, encrypts a set of content and then sends the content through a transmission line, e.g., a cable, to a DVR 104, which has a DRM system. If the content is encrypted, the DVR 104 sends the content to a content protection module 106 for decryption. Examples of the content protection module 106 include a CableCARD®, secure memory card, on-board security chip, etc. However, any component that has the capability of terminating conditional access that was protecting content transmitted to a DVR 104 and applying copy protection when sending the content to the set to box 104 may be considered a content protection module 106. Further, the content source 102 may include the content protection module 106. In other words, a single module may be both the content source 102 and the content protection module 106. For instance, a smart card that is inserted into the DVR 104 may store content and provide conditional access. Alternatively, the DVR 104 may receive content that is streamed from a device in a home network. Further, the DVR 104 is utilized as an example, and one of ordinary skill in the art will recognize that any type of device, such as a mobile phone, television with a built-in slot for a CableCARD®, smart card, subscriber identity module (“SIM”) card, etc., may be utilized. The content protection module 106 then decrypts the content. Further, in one embodiment, the content protection module 106 has an interface so that it may fit into a slot 110 of a DVR 104 and communicate with the DVR 104.

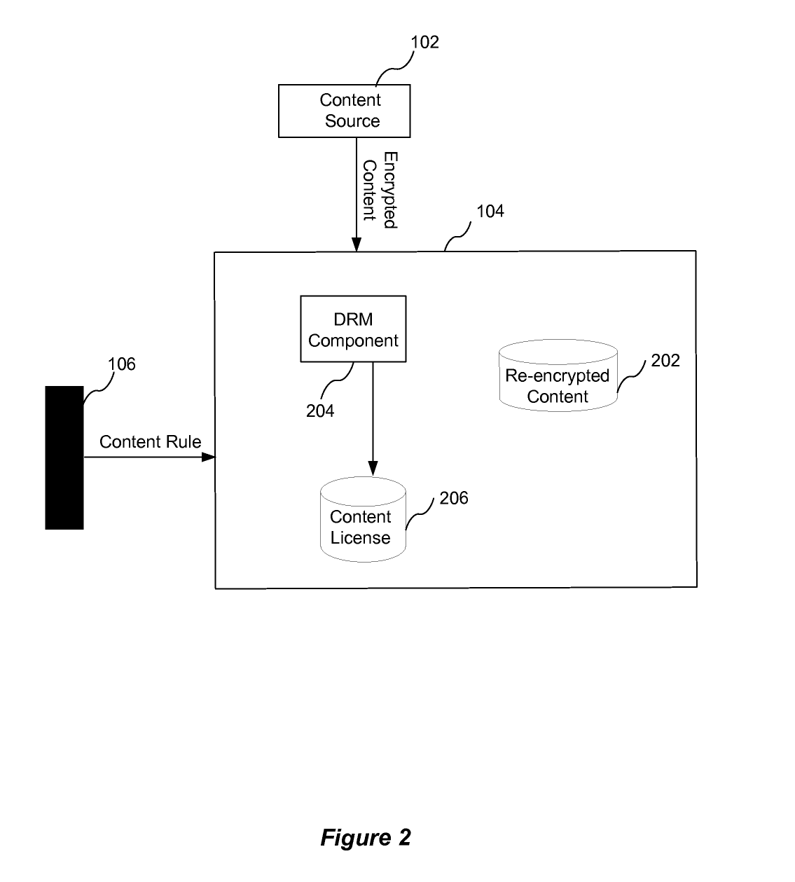

FIG. 2 illustrates the interaction between the DVR 104, the content protection module 106, and the content source 102. When the DVR 104 receives encrypted content from the content source 102, the DVR 104 may also receive one or more content rules, e.g., CCI information, via the content protection module 106. The DVR 104 requests that the content protection module 106 decrypts the content so that the DVR 104 may re-encrypt the content and record the re-encrypted content by storing it on a hard drive 202. CCI may include traditional copy control information such as Encryption Mode Indicator (“EMI”), Analog Protection System (“APS”), Constrained Image Trigger (“CIT”), Copy Generation Management System-Analog (“CGMS-A”), etc., extended CCI (including rental information, counted playbacks, etc., or other relevant content attributes such as the content resolution, e.g., High Definition vs. Standard Definition).

The DVR 104 has a DRM component 204 that composes a content license associated with the content. The content license may be stored on a storage medium 206. The DRM component 204 inserts a master key into the content license. As CCI updates are received for different segments of the content, the DRM component generates a content encryption key (“CEK”) for each segment that is utilized to re-encrypt the content for storage on the hard drive 202 or other media storage, and to decrypt the re-encrypted content during playback. In one embodiment, the DRM component 204, for each segment, stores a portion of the CCI update information. The DRM component 204 composes, and later derives, the CEK for each segment by a calculation involving the master key and a subset of the content rule associated with the segment. As an example, the subset of the content rule may include bits that are selected from the CCI information. Accordingly, the DRM component 204 may maintain a list of CCI bits associated with a set of content. Each entry in the list of CCI bits may be associated with an index that is incremented sequentially as each set of CCI bits is received. Alternatively, the index may be a random number used as a Content Key Identifier (“CKID”).

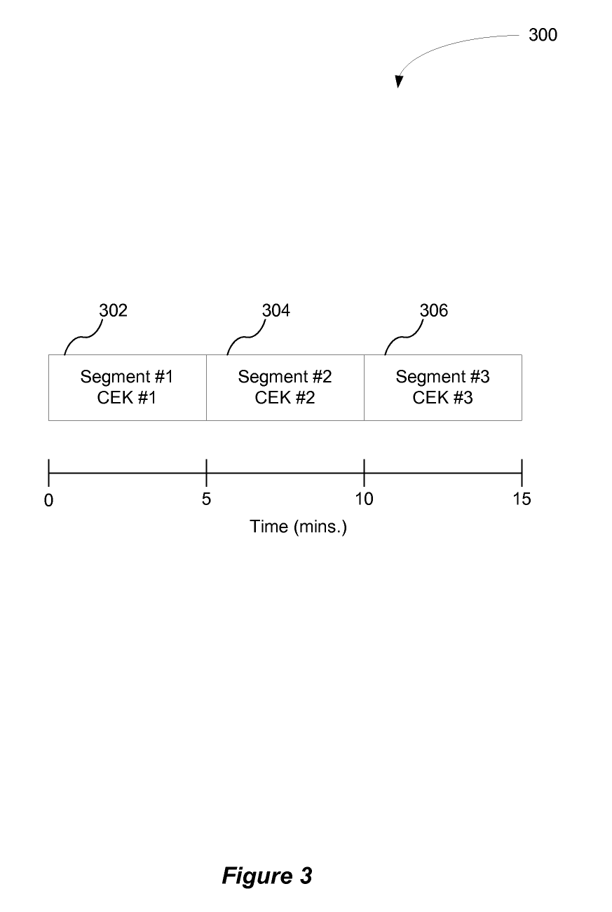

FIG. 3 illustrates an example of a plurality of segments 300 of content that may be recorded. For example, the DVR 104 illustrated in FIG. 1 may be at the point in time where fifteen minutes of two hour long copy never protected content has been recorded. In one embodiment, the copy never protected content is stored in the hard drive 202 in FIG. 2 or other media storage. An expiration content rule, e.g., copy never content rule, that is received along with the content establishes a predetermined amount of time for which the content may be temporarily stored to allow for the trick play features, e.g., ninety minutes. The predetermined amount of time may be implicit, e.g., hard coded, or provided as part of the CCI, e.g., within CCI bits, or provided by an application that is running on the DVR 104. To approximate the required secure management, the DVR 104 may characterize the content according to a plurality of segments with each segment being determined by a predetermined time sub-interval. For instance, the DVR 104 may establish a predetermined time interval of five minutes that results in characterizing the fifteen minutes of recorded content as three segments: a first segment 302, a second segment 304, and a third segment 306. The length of each of the segments may, in general, be as small as a few seconds to as long as several minutes.

In one embodiment, the DRM component 204 generates a unique CEK for each segment of copy never content at a predefined time interval during recording. For instance, the DRM component 204 may set a timer so that the DRM component 204 is automatically notified when a new time interval has begun and a new unique CEK has to be generated for the segment in the new time interval. Accordingly, the DRM component 204 may begin recording the first segment 302 by encrypting the first segment 302 with a first CEK and storing the encrypted first segment 302 in the hard drive 202 or other media storage. Further, a timer may indicate to the DRM component 204 when five minutes has elapsed, or is about to elapse, so that the DRM component 204 may generate a second CEK to encrypt the second segment 304 and store the encrypted second segment 304 in the hard drive 202 or other media storage. In addition, the timer may indicate to the DRM component 204 when the next five minutes has elapsed, or is about to elapse, e.g., ten minutes since the beginning of the recording, so that the DRM component 204 may generate a third CEK to encrypt the third segment 306 and store the encrypted third segment 306 in the hard drive 202 or other media storage. Only a small subset of the segments is shown for illustrative purposes, but the DRM component 204 may continue to characterize segments of the content according to the predetermined time intervals and generate unique CEKs for each of those predetermined time intervals all the way through the end of, for example, a two hour long content.

In one embodiment, the actual CEK for each segment is not stored in the hard drive 202 or other media storage. Rather, a time stamp, which indicates the relative time value from the beginning of the recording to the start of the segment, is generated and stored at the time that each unique CEK is determined. Each time stamp is dynamically added to the content license as the recording progresses. As a result, the content license has a master key, which is statically inserted into the content license at the time the content license is generated, and a plurality of time stamps, which are each dynamically added through the recording to correspond to a particular segment. During playback, the master key and the time stamp for a particular segment may be utilized, at least in part, to derive the CEK for that segment so that the encrypted content for that segment stored in the hard drive 202 or other media storage may be decrypted.

When a user requests playback of a particular segment, e.g., the next paused segment in order, or a jump to a segment through a trick play, a determination is made to see if the segment complies with the expiration rule. In other words, a calculation is performed utilizing the time stamp for a segment requested for playback to determine if expiration rule is complied with so that the CEK for that segment is derived. In one embodiment, the calculation involves determining if the current time minus the relative time stamp, minus the time limit from the implicit or explicit expiration content rule, minus the predetermined time interval, is before the recording start time in the content license. If the result is before the recording start time, the entire content segment is still playable. Accordingly, the master key and the time stamp for the segment may be utilized to derive the CEK for that segment. If the result is equal to or more than the recording start time, at least some portion of the content segment is not playable since it is too old. In one embodiment, the DVR 104 has access to secure time to establish the current time.

In another embodiment, the predetermined time interval is not subtracted in the calculation, so that the consumer is granted access to a segment for which any portion has not expired. Accordingly, if the current time minus the relative time stamp minus the time limit is before the recording start time, then the DRM component 204 derives the unique content encryption key for the encrypted segment based, at least in part, on the master key and the time stamp for the encrypted segment that is stored in the content license to decrypt the encrypted segment. Therefore, each segment may be played only if none of it has expired, so that no portion of the segment violates the expiration content rule.

In one embodiment, the time limit may be provided by a content provider in CCI bits of the expiration content rule. Accordingly, the content provider can customize the time limit for different locations, times, users, content, etc. In another embodiment, the time limit may be hard coded into the application in the DVR 104 so that the time limit stays the same.

In one embodiment, sequential playback of the content is effectuated by DRM component 204 remembering the last CCI element utilized. Each time that the DRM component 204 is asked to derive a new CEK and to set CCI values for protected outputs, the DRM component 204 selects the next consecutive CCI element.

In another embodiment, playback in trick mode is effectuated utilizing a marker token stored in an index file. Recorded content is usually accompanied by an index file that contains data about significant information and events, e.g., location of I-frames, changes in the program map table (“PMT”), etc. In one embodiment, a marker token is added to the index file (or a similar file) that signals an upcoming key change. The marker token includes the index and the CCI bits and any other attributes used in deriving the CEK and setting output control, e.g., a timestamp. Accordingly, when a user requests a fast forward, rewind, or jump to a particular portion of the content, the DVR 104 can look in the index file to find the current index and CCI values to provide to the DRM component 204. The DRM component 204 may then derive the CEK for the segment that the user wishes to fast forward, rewind, or jump to by utilizing the CCI value and the master key. As a result, the user is provided with a glitchless viewing experience irrespective of whether the playback is in sequential mode or trick play mode. With respect to a configuration that utilizes a stream such as an MPEG-2 stream, a dynamic array with an odd/even key indicator (also called Scrambling Control) may be utilized so that transitions between keys do not cause any picture disruption. The odd/even key may be the last bit of the index or a separate odd/even key indicator.

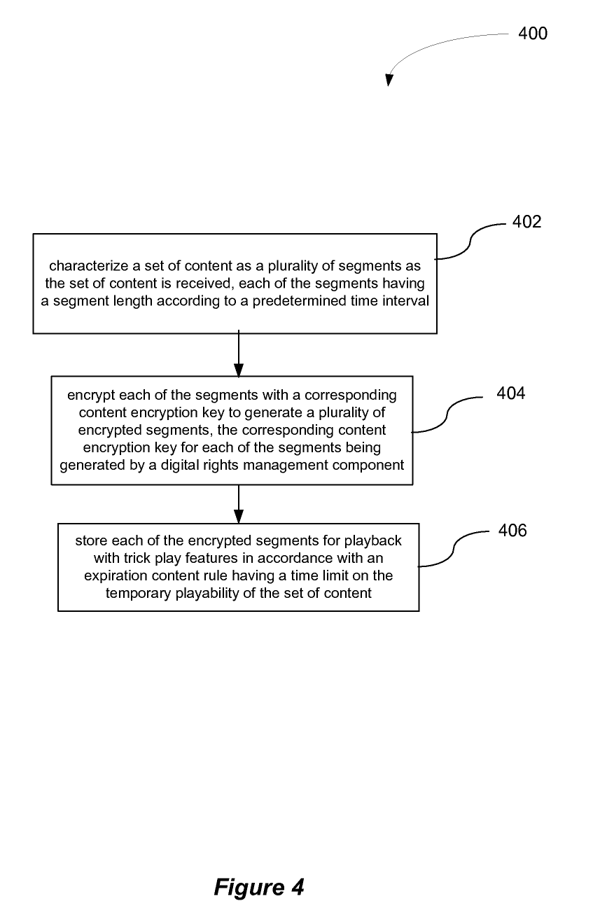

FIG. 4 illustrates a process 400 that may be utilized by the DVR 104. At a process block 402, the process 400 characterizes a set of content as a plurality of segments as the set of content is received. Each of the segments has a segment length according to a predetermined time interval. Further, at a process block 404, the process 400 encrypts each of the segments with a corresponding content encryption key to generate a plurality of encrypted segments. The corresponding content encryption key for each of the segments is generated by the DRM component 204. In addition, at a process block 406, the process 400 stores each of the encrypted segments for playback with trick play features in accordance with an expiration content rule having a time limit on the temporary playability of the set of content.

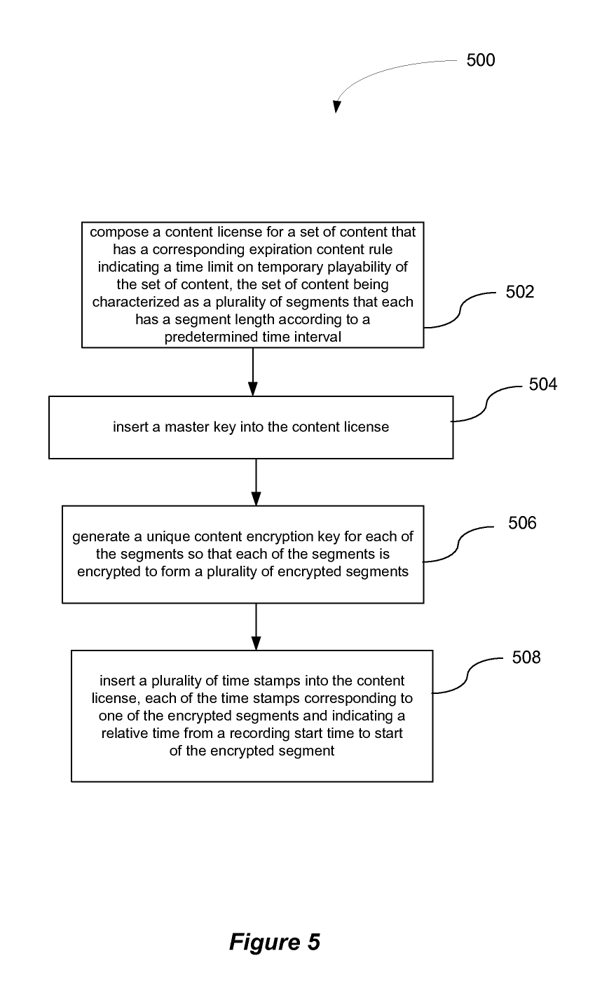

FIG. 5 illustrates a process 500 that may be utilized by the DRM component 204. At a process block 502, the process 500 composes a content license for a set of content that has a corresponding expiration content rule indicating a time limit on temporary playability of the set of content. The set of content is characterized as a plurality of segments that each has a segment length according to a predetermined time interval. Further, at a process block 504, the process 500 inserts a master key into the content license. In addition, at a process block 506, the process 500 generates a unique content encryption key for each of the segments so that each of the segments is encrypted to form a plurality of encrypted segments. Finally, at a process block 508, the process 500 inserts a plurality of time stamps into the content license. Each of the time stamps corresponds to one of the encrypted segments and indicates a relative time from a recording start time to start of the encrypted segment.

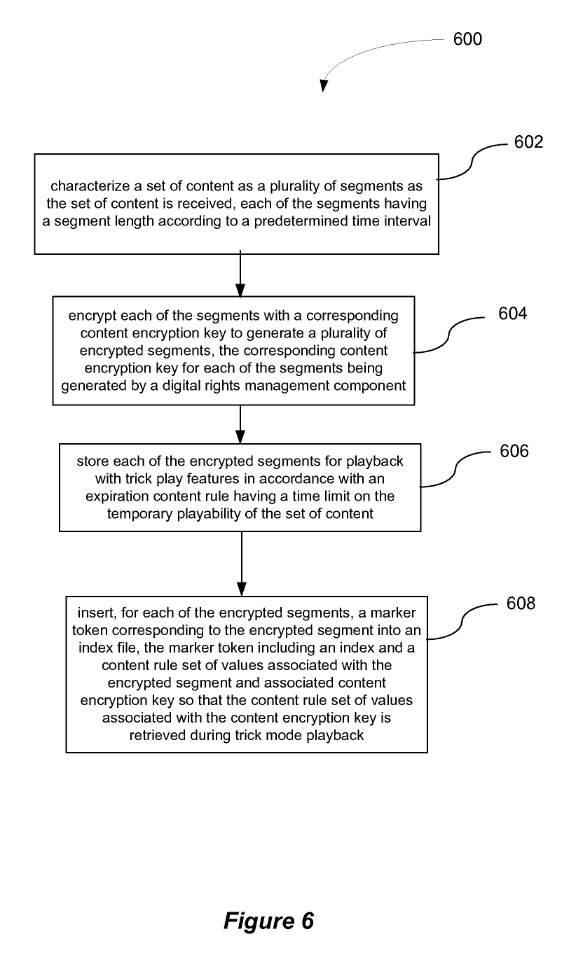

FIG. 6 illustrates another process 600 that may be utilized by the DVR 104. At a process block 602, the process 600 characterizes a set of content as a plurality of segments as the set of content is received. Each of the segments has a segment length according to a predetermined time interval. Further, at a process block 604, the process 600 encrypts each of the segments with a corresponding content encryption key to generate a plurality of encrypted segments. The corresponding content encryption key for each of the segments is generated by the DRM component 204. In addition, at a process block 606, the process 600 stores each of the encrypted segments for playback with trick play features in accordance with an expiration content rule having a time limit on the temporary playability of the set of content. At a process block 608, the process 600 inserts, for each of the encrypted segments, a marker token corresponding to the encrypted segment into an index file. The marker token includes an index and a content rule set of values associated with the encrypted segment and associated content encryption key so that the content rule set of values associated with the content encryption key is retrieved during trick mode playback.

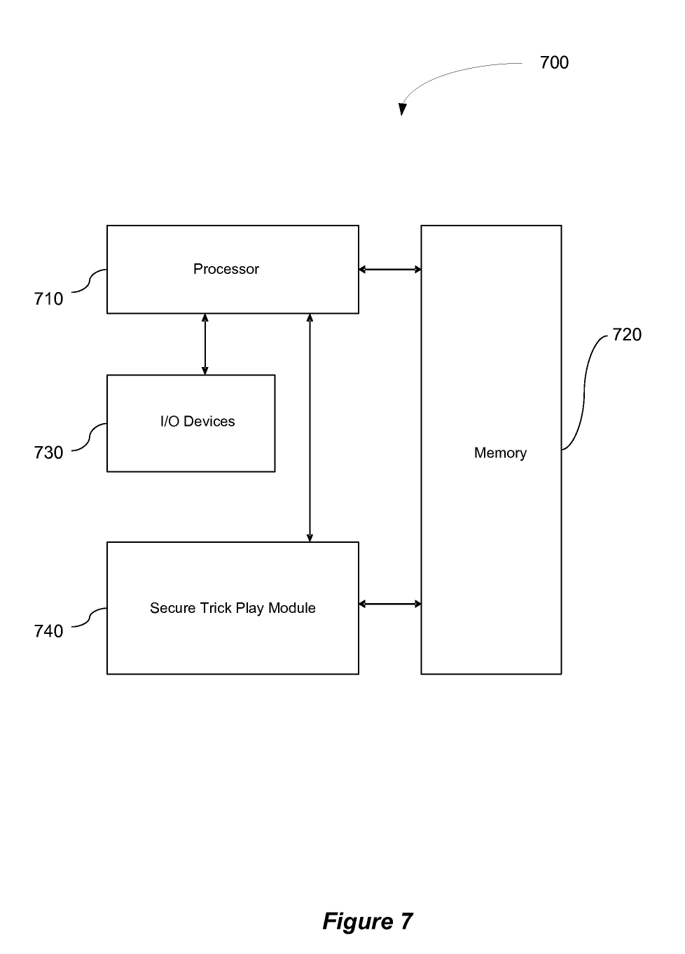

FIG. 7 illustrates a block diagram of a station or system 700 that provides secure trick play. In one embodiment, the station or system 700 is implemented using a general purpose computer or any other hardware equivalents. Thus, the station or system 700 comprises a processor 710, a memory 720, e.g., random access memory (“RAM”) and/or read only memory (ROM), a secure trick play module 740, and various input/output devices 730, (e.g., e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands). The secure trick play module 740 may include one or more processors, and/or corresponding code.

It should be understood that the secure trick play module 740 may be implemented as one or more physical devices that are coupled to the processor 710 through a communication channel. Alternatively, the secure trick play module 740 may be represented by one or more software applications (or even a combination of software and hardware, e.g., using application specific integrated circuits (ASIC)), where the software is loaded from a storage medium, (e.g., a magnetic or optical drive or diskette) and operated by the processor in the memory 720 of the computer. As such, the secure trick play module 740 (including associated data structures) of the present disclosure may be stored on a computer readable medium, e.g., RAM memory, magnetic or optical drive or diskette and the like.

It is understood that the secure trick play approach described herein may also be applied in other types of systems. Those skilled in the art will appreciate that the various adaptations and modifications of the embodiments of this method and apparatus may be configured without departing from the scope and spirit of the present method and system. Therefore, it is to be understood that, within the scope of the appended claims, the present method and apparatus may be practiced other than as specifically described herein.

We claim:

1. A method comprising:
characterizing a set of content as a plurality of segments as the set of content is received, each of the segments having a segment length according to a predetermined time interval;
encrypting each of the segments with a corresponding content encryption key to generate a plurality of encrypted segments, the corresponding content encryption key for each of the segments being generated by a digital rights management component; and
storing each of the encrypted segments for playback with trick play features in accordance with an expiration content rule having a time limit on the temporary playability of the set of content.

2. The method of claim 1, further comprising receiving the expiration content rule.

3. The method of claim 2, further comprising receiving the predetermined time interval with the expiration content rule.

4. The method of claim 1, wherein the expiration content rule is hard coded.

5. The method of claim 4, wherein the predetermined time interval is hard coded.

6. The method of claim 1, further comprising generating a time stamp for each of the encrypted segments that indicates a relative time from a recording start time to start of the encrypted segment.

7. The method of claim 6, wherein the digital rights management component inserts a master key and the time stamp for each of the encrypted segments into a content license.

8. The method of claim 7, further comprising requesting, that the digital rights management component derive the unique content encryption key for the encrypted segment based, at least in part, on the master key and the time stamp for the encrypted segment that is stored in the content license to decrypt the encrypted segment, the digital rights management component performing the derivation if the current time minus the time stamp stored in the content license, minus the time limit, minus the segment length, is before the recording start time.

9. The method of claim 7, further comprising requesting that the digital rights management component derive the unique content encryption key for the encrypted segment based, at least in part, on the master key and the time stamp for the encrypted segment that is stored in the content license to decrypt the encrypted segment, the digital rights management component performing the derivation if the current time minus the time stamp stored in the content license, minus the time limit, is before the recording start time.

10. The method of claim 1, further comprising providing a timer that automatically indicates at each of the predetermined time intervals that the digital rights management component should generate a new unique content encryption key.

11. The method of claim 1, wherein the expiration content rule is a copy never content rule.

12. The method of claim 1, wherein the time limit is located within copy control information bits.

13. The method of claim 1, wherein the time limit is located within a software application that is stored on a digital video recorder.

14. A method comprising:
composing a content license for a set of content that has a corresponding expiration content rule indicating a time limit on temporary playability of the set of content, the set of content being characterized as a plurality of segments that each has a segment length according to a predetermined time interval;
inserting a master key into the content license;
generating a unique content encryption key for each of the segments so that each of the segments is encrypted to form a plurality of encrypted segments; and
inserting a plurality of time stamps into the content license, each of the time stamps corresponding to one of the encrypted segments and indicating a relative time from a recording start time to start of the encrypted segment.

15. The method of claim 14, further comprising receiving an indication from a timer at each of the predetermined time intervals to perform the generating the unique content encryption key for each of the segments.

16. The method of claim 14, further comprising deriving, during playback, if the current time minus the time stamp stored in the content license minus the time limit is before the recording start time, the unique content encryption key for the encrypted segment based, at least in part, on the master key and the time stamp for the encrypted segment that is stored in the content license, and decrypting the encrypted segment with the unique content encryption key.

17. The method of claim 14, further comprising deriving, during playback, if the current time minus the time stamp stored in the content license minus the time limit plus the segment length, is before the recording start time, the unique content encryption key for the encrypted segment based, at least in part, on the master key and the time stamp for the encrypted segment that is stored in the content license, and decrypting the encrypted segment with the unique content encryption key.

18. The method of claim 14, wherein each of the encrypted segments is stored for future playback in accordance with the time limit and trick play features.

19. A method comprising:
characterizing a set of content as a plurality of segments as the set of content is received, each of the segments having a segment length according to a predetermined time interval;
encrypting each of the segments with a corresponding content encryption key to generate a plurality of encrypted segments, the corresponding content encryption key for each of the segments being generated by a digital rights management component;
storing each of the encrypted segments for playback with trick play features in accordance with an expiration content rule having a time limit on the temporary playability of the set of content; and
inserting, for each of the encrypted segments, a marker token corresponding to the encrypted segment into an index file, the marker token including an index and a content rule set of values associated with the encrypted segment and associated content encryption key so that the content rule set of values associated with the content encryption key is retrieved during trick mode playback.

20. The method of claim 19, wherein the expiration content rule is a copy never content rule.
